(19) United States
(12) Patent Application Publication
(10) Pub. No.: US 2005/0011608 A1
(43) Pub. Date: Jan. 20, 2005

(54) Method for diecutting a web which is provided with adhesive at least on one side and is on a backing material into individual diecuts

(75) Inventors: Ralf Schliephacke, Itzehoe (DE); Bruce Ehlers, Hamburg (DE); Michael Schwertfeger, Hamburg (DE)

Correspondence Address: NORRIS, MCLAUGHLIN & MARCUS, PA, 875 THIRD STREET, 18TH FLOOR, NEW YORK, NY, 10022, US

(73) Assignee: tesa AG, Hamburg (DE)

(21) Appl. No.: 10/830,172

(22) Filed: Apr. 21, 2004

(30) Foreign Application Priority Data
Jul. 16, 2003 (DE) 103 32 435.6

(51) Int. Cl. B32B 9/00; B32B 31/00

(52) U.S. Cl. 156/257; 156/250

(57) ABSTRACT

Method for diecutting a web which is provided with adhesive at least on one side and is on a backing material into individual diecuts, characterized in that the diecutting line of the cross-diecutting which subdivides the web into the diecuts over the entire width of the web in a non-branching line has a form other than that of a straight line, the backing material not being cut into, or only insignificantly.

The invention relates to method for diecutting a web which is provided with adhesive at least on one side and is on a backing material into individual diecuts.

Single-sided and double-sided adhesive tape diecuts are used variously at home, in the office and in industrial production.

Parts which are to be fastened by double-sided adhesive tape (for example ribbon cables, displays, cardboard packaging) are very often made completely self-adhesive in advance. This involves very considerable material consumption, and both the provision of an adhesive tape on parts exactly in line with their edges and the necessary pulling-off of the adhesive tape backing later during assembly are very time-consuming operations.

An alternative is to apply individual adhesive points directly at the assembly stage, in order then to adhesively attach the part subsequently at these points. This work is also laborious, since the adhesive points are in turn provided with a backing, which has to be removed in advance.

Depending on the application concerned, certain parts (for example electronic components or seals in mobile phones) demand the use of double-sided adhesive diecuts. These diecuts are individual portions of adhesive tape which are either arranged directly one after the other on a supporting web or are located on the supporting web at a given distance from one another, which may be regular or irregular.

These diecuts must be made up in the required form in advance in a diecutting process, in particular in what is known as the kiss-cut process, the tape that is provided with adhesive for producing the diecuts having to be provided with an anti-adhesive backing material in advance.

The kiss-cut process is distinguished by the fact that, during the diecutting, the anti-adhesive material is not damaged or cut into, or only insignificantly. This avoids adhesive of the diecuts flowing into the incisions after the diecutting operation and sticking to the material. Should this occur, the material could split in downstream production steps in which the material with the diecuts is to be further processed. In that case the entire roll would be excluded from further processing and would therefore be scrapped.

Production takes place for example by a web which is on a backing paper and may comprise a single layer of adhesive or a substrate which is provided with an adhesive at least on one side being diecut into individual diecuts, but without cutting through the backing paper.

The cross-diecuttings of such webs are carried out with straight cross-cutting lines. Furthermore, the cross-cutting blade is arranged exactly at 90° in relation to the direction of the machine. This is shown by FIG. 1. The web is divided in the direction of the machine (see arrow) into individual diecuts 50, the line of the cross-diecutting 60 being aligned at an angle of 90° in relation to the direction of the web or machine.

A variant of the method is that the web is diecut without transverse lands, that is to say without intermediate spaces between the diecuts.

In FIG. 2, double-sided adhesive tape diecuts without any transverse land (intermediate spaces) are shown. On a substrate 20 there are two adhesive layers 10, 11. The web comprising the substrate 20 and the adhesive layers 10, 11 is on a backing paper 30. After the diecutting operation (the arrow gives the direction of the machine), there are no transverse lands between the individual diecuts 1, 2, 3; the diecuts 1, 2, 3 are touching one another.

Another variant of the method is that the web is diecut with transverse lands, that is to say with intermediate spaces between the diecuts. The resulting spacing between the diecuts is dependent on the distance between the transverse cutting blades in the cutting die.

Double-sided adhesive tape diecuts with transverse land (intermediate space) 40 are shown in FIG. 3. On the substrate 20 there are two adhesive layers 10, 11. The web comprising the substrate 20 and the adhesive layers 10, 11 is on a backing paper 30. After the diecutting operation (the arrow gives the direction of the machine), there are transverse lands 40 between the individual diecuts 1, 2, 3. The material between the diecuts 1, 2, 3 is removed.

DE 101 07 294 A1 discloses, for example, a backing material web on which portions of adhesive tape made self-adhesive on both sides are arrange with transverse lands, an anti-adhesive coating having been applied to both sides of the backing material web and the two anti-adhesive coatings differing in the degree to which they repel the adhesive of the adhesive tape portions.

The backing material web can be used particularly advantageously for the adhesive attachment of individual parts in automotive engineering, but also for example in exhibition stand construction or in the packaging sector.

The cross-diecutting of the material into portions that are of a prescribed length and are defined by the cutting die dispenses with the need for separate and otherwise customary cutting to length of the adhesive tape with scissors or a knife to form the individual adhesive tape portions.

DE 196 41 094 C1 discloses a method for the loss-free diecutting of adhesive diecuts from an endless web, the web being covered at least on one side with a release laminate.

In the first method step, the web is introduced into a diecutting device, the individual contours of the diecuts being cut through in the web in the cutting line of the diecutting device without a diecutting grid. In the case of this method, the cutting line is branched. In the second method step, immediately after the diecutting operation the release laminate is pulled off by means of a dispensing edge with a small deflecting radius. In the third method step, the individual diecuts are subsequently applied to a second release laminate, the second release laminate having a higher web speed than the first release laminate, whereby individual separation of the diecuts takes place on the second release laminate.

The web speed of the second release laminate is always to be chosen according to the invention such that it is greater than that of the first release laminate. The differential speed between the first release laminate and the second release laminate at the same time defines the spacing with which the individual diecuts are deposited on the second release laminate. The higher the differential speed, the greater the spacings.

Further applications of such double-sided adhesive diecuts are to be found in the automobile sector. To be specially noted for example is the adhesive attachment of ribbon cables in car roof linings.

By contrast with conventional cable harnesses, laminated cable systems are thin, save weight and space and are very flexible and are difficult to manipulate, so that their manual assembly on a component in the interior of a passenger car is very complex and time-consuming.

Until now, these systems have been fastened in the following way: in a first production step, double-sided adhesive tapes with release paper are applied to one side of FFC cable systems at the premises of the cable harness manufacturer. In a second, later step, generally on the assembly line at the premises of the car maker, the FFC cable harness is applied to the decorative component in a way which requires the release paper to be removed manually before the cable system is positioned in the final position of the roof lining.

This process is very time-consuming and has the disadvantage, moreover, that it is not in accordance with the desire on the part of many automotive component requires manual work, with the risks of fluctuating quality levels.

One use for cross-diecut double-sided adhesive tape diecuts is the permanent fixing of ribbon cables on the interior trim of a car roof, where a defined number of individual adhesive-tape diecuts are applied to the underlying surface. For simpler application of the double-sided adhesive tape diecuts there are adhesive-tape dispensers, which pull off the uncut backing paper during the adhesive attachment of the double-sided adhesive diecut and wind up the backing paper strip with the aid of a rolling-up device.

The object of the invention is to provide a method in which diecuts which can be dispensed particularly well by means of a corresponding dispenser are produced.

This object is achieved by a method as described hereinbelow.

The invention accordingly comprises a method for diecutting a web which is provided with adhesive at least on one side and is on a backing material into individual diecuts, the diecutting line of the cross-diecutting which subdivides the web into the diecuts over the entire width of the web in a non-branching line having a form other than that of a straight line. The backing material is not cut into, or only insignificantly.

In a first preferred embodiment, the cross-diecutting has an angle of substantially 90° in relation to the 30 direction of the web.

Furthermore, the cutting line is preferably arcuate, undular, sawtooth-like or zigzag-formed.

Furthermore, any desired combinations of the stated embodiments are possible.

The backing material web is wound up into a roll in the form of an Archimedean spiral. The individual diecuts are arranged on the backing material web.

With further preference, an anti-adhesive coating has been applied to both sides of the backing material, the two anti-adhesive coatings not differing in the degree to which they repel the adhesive.

It is known for the anti-adhesive coating which is located on the upper side of the backing material to have a lower repellency than the anti-adhesive coating which is located on the lower side of the backing material. With the method according to the invention, it has successfully been achieved for the first time to use for such diecuts a backing material with identical repellencies to the adhesive on both sides.

The adhesive tape portions in this case lie on the upper side of the backing material when the latter is unrolled. This is because it is ensured in this way that
the individual adhesive tape portions can be made up and offered on the backing material web in the form of a roll without further auxiliary means (for example a second backing), and
the adhesive tape portions can be dispensed in a simple manner by a roller dispenser.

According to the invention, furthermore, highly densified glassine papers, which are provided with a polymer coating on the upper side and/or on the lower side, can be used as backing material, anti-adhesive layers, in particular silicone coatings, having been applied on both of the two polymer coatings possibly present.

In a further embodiment of the invention, a paper support with a density of 1.1 to 1.25 g/cm³ is used as backing material, the paper support substantially comprising an upper side and a lower side.

The paper support is provided on the upper side and/or on the lower side with a polymer coating, anti-adhesive layers, in particular silicone coatings, having been applied on both of the two polymer coatings possibly present.

The paper support or the glassine paper preferably has a density of 1.12 to 1.2 g/cm³, in particular 1.14 to 1.16 g/cm³. With further preference, the paper support or the glassine paper has a basis weight of 40 to 120 g/m², preferably 50 to 110 g/m², very preferably 60 to 100 g/m².

Polymers used for the polymer coating include in particular polyolefins such as LDPE, HDPE, blends of these two, for example MDPE, PP or PET. LDPE is especially advantageous.

The poly-coated sides of the LDPE or HDPE paper support can also be produced so as to be matt or glossy.

With further preference, the polymer coating is applied with 5 to 30 g/m², preferably 10 to 25 g/m², very preferably 15 to 20 g/m². In particular in the case of polyester, application may also take place with even just 2 to 3 g/m².

In addition, an outstanding development of the invention is the use of silicone, paraffin, Teflon or waxes for example as anti-adhesive layers. In that case it is possible to use silicone-free release layers, for example “non Silicone” from Rexam, or low-silicone release layers, for example “Lo ex” from Rexam.

A solvent-free coated silicone is preferably used as the anti-adhesive coating. With further preference, the anti-adhesive coating and/or the solvent-free coated silicone is applied with 0.8 to 3.7 g/m², preferably 1.3 to 3.2 g/m², very preferably 1.8 to 2.8 g/m².

However, solvent-containing systems are also possible as the anti-adhesive coating, to be precise with an application rate of in particular 0.3 to 1 g/m².

In this way it is ensured that, with a poly-coating on both sides, the backing material has
dimensionally stable properties (good flatness)
a low thickness with high consistency of thickness (narrow tolerances, more precise diecuts) and
a layer which protects against diecutting into the body of the paper.

The web preferably comprises a layer of adhesive or a substrate which is provided with an adhesive on one or both sides.

Paper, a paper-polyolefin composite and/or a film are 25 preferably used as the substrate. Suitable substrates further include, in principle, films such as, for example, POPP or MOPP, PET, PVC or nonwovens (based on cellulose or polymers). Also worthy of consideration as coating substrates are foams (for example PU, PE, PE/EVA, EPDM, PP, PE, silicone, etc.) or release papers (kraft papers, polyolefin-coated papers) or release films (PET, PP or PE or combinations of these materials).

All pressure-sensitive adhesives, such as are mentioned, for example, in SATAS, Handbook of Pressure Sensitive Adhesive Technology, Third Edition, can be used as the adhesives. Particularly suitable are natural/synthetic rubber-based and acrylate-based adhesives which can be applied from the melt or solution.

During production, further processing or later stressing of polymers or of polymer compositions, it is possible for high degrees of orientation of the macromolecules to form in preferred directions in the overall polymer assembly; as a result of this orientation, which can also be induced deliberately, it is possible to control the properties of the corresponding polymers and to improve them in respect of desired applications. Anisotropically oriented pressure-sensitive adhesives have the tendency to return to the initial state following stretching in a given direction, as a result of their “entropy-elastic behaviour”. Suitable for use in principle in the diecuts are all pressure-sensitive adhesives which have an orientation, examples being those based on natural and synthetic rubbers such as butyl rubber, neoprene, butadiene-acrylonitrile, styrene-butadiene-styrene and styrene-isoprene-styrene copolymers, and also those based on linear polyesters and copolyesters, polyurethanes, polysiloxane elastomers, those based on pure acrylates, but especially polyacrylate-based anisotropic pressure-sensitive adhesives. Such anisotropically oriented acrylate pressure-sensitive adhesives, in the form of a layer after diecutting and/or cutting operations, exhibit a retreat of the pressure-sensitive adhesive layer at the cut and diecut edge, which is utilized for the cutting out of diecut forms which do not coalesce.

One advantageous development uses a pressure-sensitive adhesive
which is obtainable by free-radical polymerization,
which is composed to the extent of at least 65% by weight on at least one acrylic monomer from the group of compounds of the following general formula: 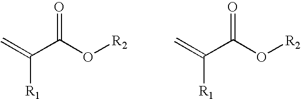
   where R₁=H or CH₃ and the radical R₂=H or CH₃ or is selected from the group of branched or unbranched, 5 saturated alkyl groups having 2 to 20 carbon atoms, preferably 4 to 9 carbon atoms, for which the average molecular weight of the pressure-sensitive adhesive is at least 650,000, and which, when applied to a support, has a preferential direction, the refractive index measured in the preferential direction, n_{MD}, being greater than the refractive index measured in a direction perpendicular to the preferential direction, n_{CD}, and the difference Δn=n_{MD}−n_{CD} amounting to at least 1×10⁻⁵.

Non-exclusive examples of alkyl groups which may find preferred application for the radical R₂ include butyl, pentyl, hexyl, heptyl, octyl, isooctyl, 2-methylheptyl, 2-ethylhexyl, nonyl, decyl, dodecyl, lauryl, or stearyl (meth) acrylate or (meth) acrylic acid.

The diecutting method is also excellent when using a pressure-sensitive adhesive based to an extent of up to 35% by weight on comonomers in the form of vinyl compounds, especially one or more vinyl compounds selected from the following group: vinyl esters, vinyl halides, vinylidene halides, nitriles of ethylenically unsaturated hydrocarbons.

As far as use is concerned, the term “vinyl compound” also includes acrylic compounds with functional groups. Such vinyl compounds containing functional groups are maleic anhydride, styrene, styrenic compounds, vinyl acetate, (meth) acrylamides, N-substituted (meth) acrylamides, β-acryloyloxyproprionic acid, vinylacetic acid, fumaric acid, crotonic acid, aconitic acid, dimethylacrylic acid, trichloroacrylic acid, itaconic acid, vinyl acetate, hydroxyalkyl (meth) acrylate, amino-containing (meth) acrylates, hydroxyl-containing (meth) acrylates, especially preferably 2-hydroxyethyl(meth)acrylate, 2-hydroxypropyl (meth) acrylate, and/or 4-hydroxybutyl meth) acrylate, and double-bond-functionalized photoinitiators; the above listing is only exemplary and not exhaustive.

For the pressure-sensitive adhesives it is especially advantageous if the composition of the corresponding monomers is chosen such that the resultant adhesives have pressure-sensitive adhesion properties in accordance with D. Satas [Handbook of Pressure Sensitive Adhesive Technology, 1989, VAN NOSTRAND REINHOLD, New York]. For this purpose, the glass transition temperature f the acrylate pressure-sensitive adhesive should lie, for example, below 25° C.

The pressure-sensitive adhesives that are used, 25 particularly the polyacrylate pressure-sensitive adhesives praised above for their advantage, are preferably prepared by a free-radically initiated polymerization. One process very suitable for this purpose is distinguished by the following steps:
polymerization of a mixture comprising at least one vinyl-, acrylor methacryl-based monomer or a combination of these polymers, the average molecular weight of the resultant polymers lying above 650,000,
subsequent extrusion coating of the polymer composition,
subsequent crosslinking of the polymer composition on the support by irradiation with electron beams.

The extrusion coating preferably takes place in this case through an extrusion die. The extrusion dies used may come from one of the following three categories: T-dies, fishtail dies and coathanger dies. The individual types differ in the design of their flow channel. For the preparation of oriented acrylate pressure-sensitive adhesives, it is particularly preferred to carry out coating onto a support using a coathanger die, to be precise in such a way that a layer of polymer is formed on the support by a movement of the die in relation to the support. The time period between the coating and the crosslinking is advantageously very short, preferably no greater than 10 s. As a result of the shaping of the acrylate hotmelt in the coathanger die and its emergence from the die with a defined film thickness, as a result of the stretching of the film of pressure-sensitive adhesive as it transfers to the substrate, to give a thinner film thickness, and as a result of the subsequent in-line crosslinking, the orientation is obtained.

The free-radical polymerization can be conducted in the presence of an organic solvent or in the presence of water or mixtures of organic solvents and water or in bulk. It is preferred to use as little solvent as possible. Depending on conversion and temperature, the polymerization time amounts to between 6 and 48 h.

In the case of solution polymerization, the solvents used are preferably esters of saturated carboxylic acids (such as ethyl acetate), aliphatic hydrocarbons (such as n-hexane or n-heptane), ketones (such as acetone or methyl ethyl ketone), special boiling-point spirit or mixtures of these solvents. For polymerization in aqueous media or mixtures of organic and aqueous solvents, the emulsifiers and stabilizers known for this purpose to a person skilled in the art are added to the polymerization. Polymerization initiators used are customary radical-forming compounds such as for example peroxides, azo compounds and peroxosulphates. Initiator mixtures can also be used. During the polymerization, further regulators can be used to lower the molecular weight and to reduce the polydispersity. Alcohols and ethers can be used for example as so-called polymerization regulators. The molecular weight of the acrylate pressure-sensitive adhesives advantageously lies between 650,000 and 2,000,000 g/mol, more preferably between 700,000 and 1,000,000 g/mol).

In a further procedure, the polymerization is carried out in polymerization reactors which are generally provided with a stirrer, a number of feed vessels, a reflux condenser, heating and cooling and are equipped for operation under an N₂ atmosphere and superatmospheric pressure

Following the polymerization in solvent, the polymerization medium can be removed under reduced pressure, this operation being conducted at elevated temperatures, for example in the range of 80 to 150° C. The polymers can then be used in the solvent-free state, in particular as hotmelt pressure-sensitive adhesives. In some cases, it is also advantageous to prepare the polymers according to the invention in bulk.

To prepare the acrylate pressure-sensitive adhesives, the polymers may be modified in a customary way. For example, tackifying resins, such as terpene, terpene-phenolic, C₅, C₉ and C₅/C₉ hydrocarbon, pinene, indene or colophony resins can be added, alone or in combination with one another. It is also possible, furthermore, to used plasticizers, various fillers (for example fibres, carbon black, zinc oxide, titanium dioxide, solid microbeads, solid or hollow glass beads, silica, silicates, chalk, blocking-free isocyanates, etc.), ageing inhibitors, light stabilizers, ozone protectants, fatty acids, nucleating agents, expandants and/or accelerants as additives. Crosslinking agents and crosslinking promoters can also be mixed in. Examples of suitable crosslinking agents for electron beam crosslinking are difunctional or multifunctional acrylates, difunctional or multifunctional isocyanates or difunctional or multifunctional epoxies.

The acrylate hotmelts, as they are or in the form of blends, are coated onto the substrate through a die with a variable slot width and are then cured on the support by electron beams. The crosslinking takes place in in-line operation immediately after the pressure-sensitive adhesive has been applied to the support.

The adhesive attachment of diecuts provided with adhesive on both sides, which have been diecut by the method according to the invention, takes place particularly advantageously by means of a device for unrolling a backing material web, present on a roll, with the diecuts that are provided with adhesive on both sides, the device comprising
a handle fitted to a holding plate,
a receiver mounted rotatably on the holding plate and intended for the roll of backing material web,
a pressure roller which is mounted rotatably on the holding plate and, during the dispensing operation, brings the backing material web with the diecuts into contact with the underlying surface, and by means of which the backing material web with the diecuts is guided from the receiver for the roll in such a way that the diecuts are dispensed onto the underlying surface from the backing material web during the dispensing operation,
a drive roller which is mounted rotatably on the holding plate and by means of which the backing material web with the diecuts is guided in such a way that the drive roller rotates synchronously with respect to the speed of the backing material web,
a receiving roller which is mounted rotatably on the holding plate and receives the backing material web after the diecuts have been dispensed, and in particular is set in rotation via a belt by the movement of the drive roller.

In a further preferred embodiment, the drive roller is arranged between the receiver for the roll of backing material web and the pressure roller.

In a further preferred embodiment, a guide roller is arranged between the receiver for the roll of backing material web and the drive roller, in order to produce a very high angle of wrap of the backing material web around the drive roller. In this way, secure transmission of the movement of the backing material web to the drive roller, and consequently via the preferred belt to the receiving roller, is ensured.

With further preference, on a spindle which can be fixed on the handle there is an adjustable positioning aid, in particular in the form of a rotatable shaft which can be fixed by screwing and via which the backing material web is guided from the receiver for the roll of backing material web in the direction of the drive roller.

This positioning aid, comprising in particular a shaft which is to be guided movably in a groove and can be fixed at any desired position within the groove by screwing, serves the purpose of ensuring, depending on the application of the diecuts, that the beginning and/or end of the diecuts, especially diecuts that are self-adhesive on both sides, is always at predetermined position, in order that the adhesive attachment always begins in a defined manner at the beginning of a portion with a length of, for example, 15 mm and that, after the dispensing operation, that is when for example the device has been drawn once over a portion of a ribbon cable, the adhesive attachment stops at the end of another portion with a length of, for example, 15 mm.

Another exemplary solution for a positioning aid of this type may be an additional, small magnifying glass with marking, which can be positioned in the same way.

The distance between the pressure roller and the positioning aid is individually adjustable, adapted to the length of the diecuts that are self-adhesive on both sides. By means of this positioning aid, the user of the device is always able to stay within the register given by the length of the diecuts.

In order to make the device easy to use for both left-handers and right-handers, the handle and all other components can be mounted in mirror-image form on the holding plate.

In a further preferred variant, in the receiver for the roll of backing material web there is an adjustable brake, in particular a friction brake. This provides a uniform tension, which is not too low, in the backing material web during the dispensing operation.

In a further preferred embodiment, one side of the pressure roller is fixed on the holding plate and the other side carries a counterplate. In the case of the device which is pushed during the dispensing operation, the counterplate and the holding plate are of a prolonged form in the direction of the handle. The counterplate and the holding plate are harmonized in their shape with the pressure roller and with the lever arm of the handle in such a way that, at the end of the dispensing operation, the entire device can easily be tilted by the user about the fulcrum which arises from this geometry. As a result of this rotational movement, in conjunction with the positioning aid, on the one hand it is always possible still to dispense the last diecut reliably, that is to say to transfer it from the backing material web to the underlying surface, while on the other hand the next diecut, not to be adhesively attached until later, is still held securely on the backing material web.

Polymers are suitable as materials for the components, but a metal version is also possible.

The combination of the device and the backing material web offers many advantages which, as such, were not to be foreseen. The dispensing of the diecuts is not accompanied by any loss of time owing to the pulling off of a backing and involves less waste. Different sizes of the diecuts adhesively attached in different numbers—make it possible, so to speak, to “dose” the required amount of adhesive tape.

Diecuts that are self-adhesive on both sides and are arranged without gaps on the backing material web, that is for example a 15 mm wide web that is self-adhesive on both sides and has a transverse separation every 15 mm, are preferably used. In other words, a stretch of adhesive of, for example, 90 mm is replaced by 6 diecuts of 15 mm. Any other desired dimensions are similarly conceivable. The diecuts of 15 mm in length also allow an inherently rigid web that is self-adhesive on both sides with an intermediate carrier to be adhesively attached in curves with the assistance of the device.

Particularly advantageous embodiments of the invention are explained in more detail on the basis of the figures described below, without thereby wishing restrict the invention unnecessarily.

### BRIEF DESCRIPTION OF THE DRAWINGS

In the drawings:

FIG. 1 shows a diecutting operation according to the prior art, in which the cross-cutting blade is arranged exactly at 90° in relation to the direction of the machine,

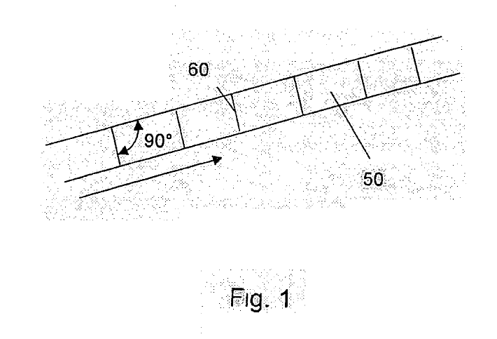

FIG. 2 shows double-sided adhesive-tape diecuts with transverse land (intermediate space), as are known from the prior art,

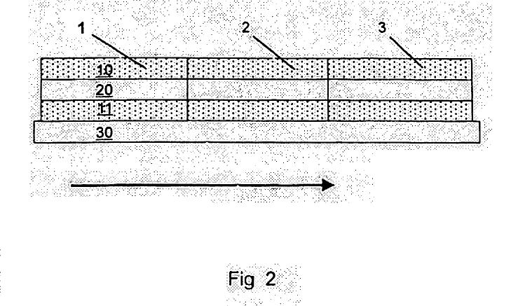

FIG. 3 shows double-sided adhesive-tape diecuts without transverse land (intermediate space), as are known from the prior art,

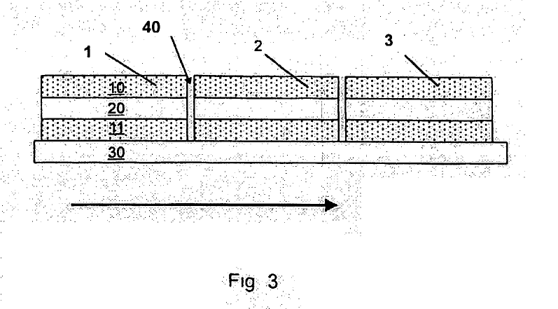

FIG. 4 shows the comparison of a cross-diecutting according to the prior art with a cross-diecutting according to the invention, to be precise in undular form,

FIG. 5 shows the force conditions occurring in the cross-diecuttings according to FIG. 4,

FIG. 6 shows different embodiments of the cross-diecutting,

FIG. 7 shows the device by means of which the diecuts produced by the method according to the invention can be dispensed, and

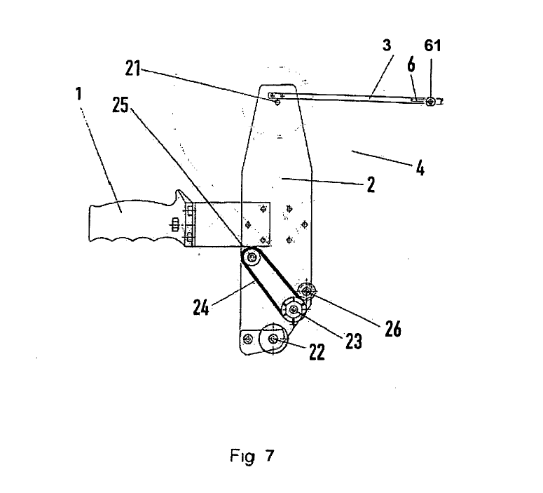

FIG. 8 shows the design of the rotational diecutting cylinder.

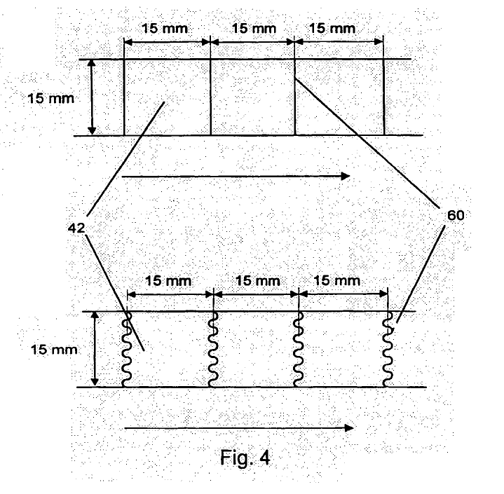

Represented in FIG. 4 is the comparison of a cross-diecutting 60 according to the prior art with a cross-diecutting 60 according to the invention, to be precise in undular form. The arrow indicates the direction of the machine. The cross-diecutting 60 of the web with the width of 15 mm takes place every 15 mm. The known diecutting method produces diecuts 42 with a length of 15 mm. The method, according to the invention likewise makes the diecuts 15 mm long, but they have undular transverse edges.

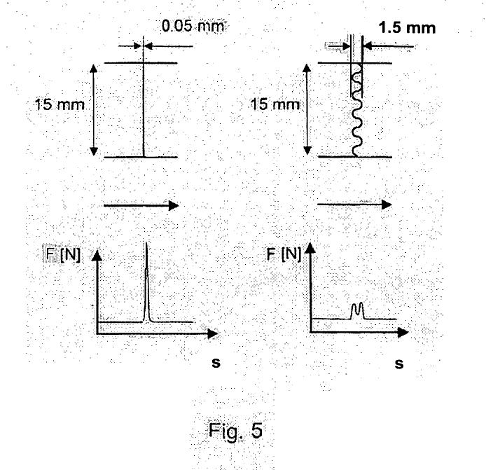

FIG. 5 shows the force conditions occurring in the cross-diecuttings according to FIG. 4, to be precise in each case the diecutting force of a rotational diecutting cylinder, in one case with a straight die blade, in the other case with an undular die blade. A form of diecutting line other than that of a straight line has the effect that the pressure of the diecutting line of the die at the time of full engagement of the diecutting die blade in the material being cut is reduced and distributed over a greater displacement, which at the same time corresponds to a greater time duration. The rotational diecutting die and the rotational diecutting machine are loaded with lower diecutting line pressure with regard to force absorption and load distribution. The force peaks occurring with straight cross-diecutting blades do not occur in the case of non-straight diecutting line geometries—as illustrated by the diagrams of FIG. 5.

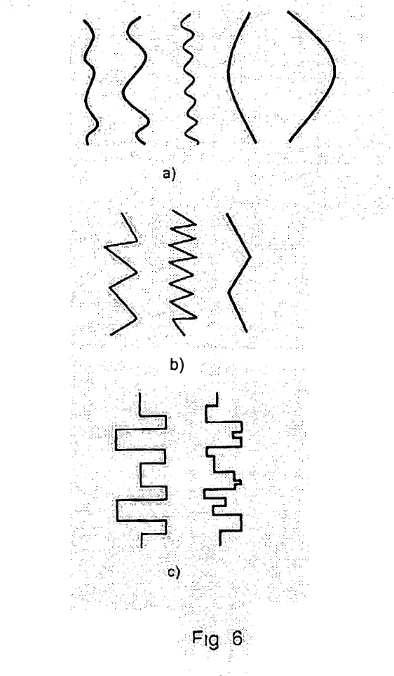

FIG. 6 shows various embodiments of diecutting lines formed according to the invention. They are essentially not straight, that is for example arcuate. They may also be undular, sawtooth-like and/or a zigzag-formed. In addition, regularly shaped diecutting lines are preferred (examples a3, b2, c1). However, the method can be carried out with irregularly shaped lines (see in particular example c2).

FIG. 6 shows the device for unrolling a backing material web, present on a roll 4, with in particular diecuts 42 that are provided with adhesive on both sides. The device is composed of a number individual components. The central component is the holding plate 2, which serves for accommodating all the other components, such as a handle 1 which is screwed on the holding plate 2. Simply changing the position of the handle 1 allows the device to be moved in a pulling movement, and also in particular a pushing movement, during the dispensing operation. The device is preferably pushed, because a greater pressing force, which is advantageous for pressure-sensitive self-adhesives, is much easier to apply ergonomically in the case of a pushing movement.

A rotatably mounted receiver 21 for the roll 4 of backing material web 41 is then provided on the holding plate 2.

Also present is a pressure roller 22, which is mounted rotatably on the holding plate 2, brings the backing material web with the diecuts 42 into contact with the underlying surface during the dispensing operation and, via 21 for the roll 4, is guided in such a way that the diecuts 42 are dispensed from the backing material web onto the underlying surface during the dispensing operation. The material and diameter of the pressure roller 22 are such that on the one hand a sufficient applied pressure is ensured for the adhesive attachment of the self-adhesive diecuts 42 and on the other hand the backing material web can be removed without any problem from the diecuts 42 that are self-adhesive on both sides. In this case the said roller 22 is specifically designed appropriately for the properties of the double-sided self-adhesive diecuts 42 on the backing material web.

By way of a drive roller 23 mounted rotatably on the holding plate 2, the backing material web with the diecuts 42 is guided in such a way that the drive roller 23 rotates synchronously with respect to the speed of the backing material web.

The drive roller 23 is arranged between the receiver 21 for the roll 4 and the pressure roller 22.

In order that the backing material web has a large angle of wrap around the drive roller, a guide roller 26 is arranged between the receiver 21 for the roll 4 of backing material web and the drive roller 23, and is in turn surrounded by the backing material web.

Finally, on the holding plate 2 there is a rotatably mounted receiving roller 25, which receives the backing material web after the diecuts 42 have been dispensed and is set in rotation by the movement of the drive roller 23, in particular via a belt 24. Provided on the holding device 2, on a fixable spindle 3, is an adjustable positioning aid 6, to be precise in the form of a rotatably mounted shaft 61 which can be fixed by screwing and via which the backing material web is guided from the receiver 21 for the roll 4 in the direction of the drive roller 23.

One side of the pressure roller 22 is fixed on the holding plate 2 and the other side carries a counterplate. In the case of the device which is pushed during the dispensing operation, the counterplate and the holding plate 2 are of a prolonged form in the direction of the handle 1. The counterplate and the holding plate 2 are harmonized in their shape with the pressure roller 22 and with the lever arm of the handle 1 in such a way that, at the end of the dispensing operation, the entire device can easily be tilted by the user about the fulcrum which arises from this geometry. As a result of this rotational movement, in conjunction with the positioning aid 6, on the one hand it is always possible still to dispense the last diecut 42 reliably, that is to say to transfer it from the backing material web to the underlying surface, while on the other hand the next diecut 42, not to be adhesively attached until later, is still held securely on the backing material web.

The entire device is appropriately designed in such a way that, both with an empty receiving roller 25 and with a full receiving roller 25, there is no adverse effect on the positioning accuracy of the double-sided self-adhesive diecuts 42. This applies in particular to the transmission ratio of the belt drive between the rollers 23 and 25.

The invention is explained in more detail below by means of an example, also without the intention of any restriction.

### EXAMPLE

A double-sided adhesive tape (tesafix 51965), which comprises two layers of adhesive each with a composition application of 100 g/m² on a substrate located there between, to be precise a 12 μm thick polyester film, and also a polymer-coated backing paper, with a width of 15 mm, is diecut, to be precise into diecuts of a length of likewise 15 mm.

The diecutting takes place on a laboratory rotational diecutting machine. Undular cross-diecuttings are carried out in a working width (corresponds to the diecutting width) of 160 mm by the kiss-cut method.

The spacing between the cross-diecutting lines is 15 mm.

The diecutting process in the rotational diecutting 5 machine is constituted as follows:
unwinding of the roll of double-sided adhesive tape
kiss-cutting of the adhesive tape web with the aid of a rotational diecutting cylinder
winding up of the diecut adhesive tape web to form a roll.

The rotational diecutting cylinder is designed as follows

| | |
|---|---|
| serration: | ⅛ CP 20 |
| number of teeth: | 71 |
| circumference: | 235.43 mm |
| transverse grooves: | 1 |
| dimension: | 160 mm |
| number of | |
| longitudinal grooves: | 15 |
| corner radius: | ./. |

An undular sine curve with R=0.75 mm was diecut.

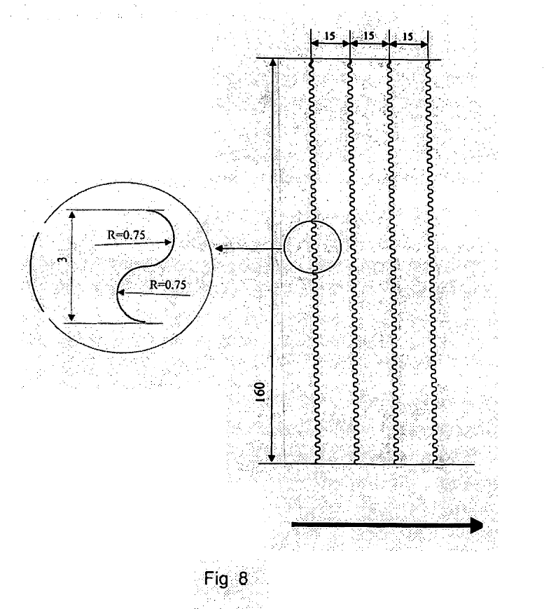

The details are shown in FIG. 8. The arrow in turn indicates the direction of the machine. It is explained in the cutout which dimensions the undular sine curve has.

Diecutting is performed into the adhesive side of a double-sided adhesive tape with a running length of 250 m (tesafix 51965), without cutting into the backing paper that is polymer-coated on both sides.

The speed of the diecutting machine is as a minimum speed v=2 m/min, as a maximum speed v=50 m/min.

After the diecutting operation, a separate working step is performed, comprising longitudinal cutting, winding the rolls and individually separating the diecut rolls in dimensions of 15 mm in width and 100 m in length on a paperboard core of 76 mm in diameter. This produces a virtually endless tape on which diecuts measuring 15×15 mm are arranged one behind the other.

In the comparative test with straight cross-diecutting, a maximum application rate of 0.3 m/s is obtained when dispensing the diecuts with a device as explained above. In the case of the undular cross-diecutting according to the invention, a maximum application rate of 2.0 m/s is obtained.

The comparison shows that “non-straight” cross-diecutting forms permit a faster application of the diecuts in contrast to a straight form of the diecutting line.

The non-straight diecutting line geometry has the effect that greater cohesive forces are produced than in the case of a straight diecutting line. The holding forces between the two diecuts are produced by the flow properties of the adhesive at the cut edge after the cross-diecutting. The longer the cut edge, the more flowing adhesive that bonds again after the cut. The greater, therefore, are the cohesive forces between the diecuts.

The greater, in turn, the cohesive forces between the individual diecuts, the faster the adhesive-tape diecuts can be applied.

Another advantage, a complete surprise to a person skil led in the art, is that a non-straight form of cross-cutting blade has a lower diecutting line pressure in the rotational diecutting die at the time of the rotational diecutting.

A form of diecutting line other than that of a straight line, for example an undular form, has the effect that the pressure of the diecutting line of the die at the time of full engagement of the diecutting die blade in the adhesive tape is reduced and distributed over a greater displacement, which at the same time corresponds to a greater time duration.

The rotational diecutting die and the rotational diecutting machine are loaded with lower diecutting line pressure with regard to force absorption and load distribution. The force peaks occurring with straight cross diecutting blades do not occur in the case of non 15 straight diecutting line geometries.

The non-straight form of diecutting line produces greater cohesive forces between two cross-diecut adhesive-tape diecuts than a straight form of diecutting line. The cohesive forces between two cross-diecut diecuts, which can be influenced by the length of the diecutting line and by the embodiment, are to be used to shape the characteristics of the backing papers with regard to their detaching properties with standardized properties. Backing papers are usually provided with different silicone coatings on the lower side and the upper side. These different silicone coatings ensure reliable handling and that the diecuts remain on the desired side of the backing paper when the roll of double-sided adhesive tape is unrolled.

With a non-straight form of diecutting line, backing papers with identical silicone coating on both sides can also be used, something which is not possible with a straight form of diecutting line. The silicone coatings on the backing paper must be different in the case of a straight form of diecutting line.

The following application possibilities arise with the diecuts produced by the method according to the invention:
Double-sided adhesive diecuts for the adhesive attachment of items such as for example fillets, ribbon cables, paper strips or film strips, in particular for the permanent fixing of ribbon cables on the interior trim of car roofs, where a defined number of individual adhesive-tape diecuts are applied to the underlying surface.
Single-sided adhesive diecuts on a backing paper for the adhesive attachment and marking of items, for example for the marking of cables, CDs, floppy disks.

It should be understood that the preceding is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. Method for diecutting a web into individual diecuts, said web being provided with adhesive at least on one side thereof and being on a backing material, said method comprising cross-diecutting along a diecutting line subdividing the web into the diecuts over an entire width of the web, said diecutting line being a non-branching line having a form other than that of a straight line, wherein during the cross-diecutting the backing material is not cut into, or is cut into only insignificantly.

2. Method according to claim 1, wherein the cross-diecutting has an angle of substantially 90° in relation to the direction of the web.

3. Method according to claim 1, wherein the diecutting line is arcuate, undular, sawtooth-like and/or zigzag-formed.

4. Method according to claim 1, wherein the web comprises a layer of adhesive or a substrate which is provided with an adhesive on one or both sides.

5. Method according to claim 1, wherein anti-adhesive coatings have been applied to both sides of the backing material, the two anti-adhesive coatings not differing substantially in the degree to which they repel the same layer of adhesive.
